(19) United States
(12) Patent Application Publication
(10) Pub. No.: US 2025/0046201 A1
(43) Pub. Date: Feb. 6, 2025

(54) ARITHMETIC PUZZLE LEARNING APPARATUS AND METHOD OF USE

(71) Applicant: Learn With Ame, LLC, Dallas, TX (US)

(72) Inventor: Amelyza H. Martinez Guerra, Dallas, TX (US)

(21) Appl. No.: 18/791,376

(22) Filed: Jul. 31, 2024

Related U.S. Application Data
(60) Provisional application No. 63/516,818, filed on Jul. 31, 2023.

(51) Int. Cl. G09B 1/06; A63F 9/06; A63F 9/10; A63F 9/12; G09B 19/22

(52) U.S. Cl. CPC G09B 1/06; A63F 9/0612; A63F 9/1044; A63F 9/12; G09B 19/22

(57) ABSTRACT

An arithmetic puzzle learning apparatus and method of use is provided. The apparatus comprises a plurality of puzzle pieces, each piece featuring a numbering device corresponding to a sequential numbering system. When solved, the pieces form to reveal a hidden image, promoting learning and retention of arithmetic concepts. The puzzle pieces can be assembled on either a physical board or a digital platform, with the latter providing interactive features such as animations and real-time feedback. This educational tool caters to various skill levels, offering adjustable difficulty and comprehensive guidelines to facilitate a structured and interactive learning experience.

### CROSS-REFERENCE TO RELATED APPLICATION

This application claims the benefit of U.S. Provisional Patent Application No. 63/516,818, filed Jul. 31, 2023, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to an educational tool, and more specifically, to an arithmetic puzzle learning apparatus for helping teach math concepts, such as counting, basic arithmetic, and number sense through interactive play.

### 2. Description of Related Art

This background information is intended to further educate the reader as to additional aspects of the prior art and may present examples of specific aspects of the prior art that is not to be construed as limiting the disclosure of the present application.

The field of education has long recognized the significance of hands-on learning and engagement in the effective instruction of elementary age children. Traditional teaching methods often rely on passive learning approaches, which can lead to disinterest and limited retention of information. As a result, there is a growing demand for interactive educational tools that combine playfulness with academic content to foster active participation and enhance the learning experience.

Mathematics education, in particular, poses unique challenges due to its abstract nature and the need for strong foundational skills. Elementary age children often struggle with grasping mathematical concepts, which can hinder their future academic success. Therefore, there is a pressing need for innovative approaches that make mathematics engaging, relatable, and accessible to young learners.

The incorporation of play into educational practices has been widely acknowledged as an effective strategy for promoting cognitive development and engagement. Playful learning environments have been found to increase motivation, creativity, and critical thinking skills in children. By turning educational activities into enjoyable experiences, children are more likely to actively participate, explore, and retain knowledge.

Additionally, pattern-seeking activities have been recognized as valuable tools for enhancing cognitive abilities, concentration, and problem-solving skills. Engaging in pattern-seeking exercises stimulates the brain's neural networks and encourages hyperfocus, allowing learners to deeply immerse themselves in the learning process. Furthermore, pattern recognition skills have practical applications beyond mathematics, as they contribute to the development of analytical thinking and logical reasoning.

The present invention addresses the aforementioned needs by introducing an arithmetic puzzle learning apparatus that combines interactive play, mathematical problem-solving, and pattern-seeking concepts. The tool aims to transform mathematics education by providing a captivating and engaging learning experience for elementary age children. By integrating a unique numbering system into puzzle pieces, learners are encouraged to solve arithmetic problems to reveal an image. The interactive nature of the puzzle tool promotes active participation and hands-on learning, enabling children to develop their mathematical skills in an enjoyable and immersive manner.

Moreover, the incorporation of pattern-seeking exercises within the puzzle design enhances the learning experience by promoting hyperfocus and relaxation. By engaging in focused problem-solving activities, learners can enhance their concentration, critical thinking, and pattern recognition abilities. These skills are essential for success in mathematics and have broader applications across various academic disciplines.

Accordingly, there exists a need for an arithmetic puzzle learning apparatus for helping teach math concepts, such as counting, basic arithmetic, and number sense through interactive play to address the challenges associated with traditional teaching methods.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The present invention introduces an arithmetic puzzle learning apparatus designed to teach math concepts through interactive play. This innovative tool caters specifically to elementary age children and targets the educational toys industry, including teachers, schools, and educational institutions.

The arithmetic puzzle learning apparatus incorporates a unique numbering system into puzzle pieces, where the focus is on solving arithmetic problems to reveal an image. By engaging in this interactive and hands-on activity, children are actively involved in the learning process, promoting deeper comprehension and retention of mathematical concepts.

Furthermore, the arithmetic puzzle learning apparatus embraces the pattern-seeking concept, encouraging learners to engage in focused problem-solving activities. This approach not only enhances the learning experience but also promotes hyperfocus and relaxation, thereby maximizing the effectiveness of the educational process.

The puzzle can be implemented as either a physical or digital product, providing flexibility and adaptability to different learning environments. It may also take the form of both 2-dimensional and 3-dimensional puzzle designs, enabling dynamic interaction and diverse learning opportunities.

By combining interactive play, mathematical problem-solving, and pattern-seeking activities, the arithmetic puzzle learning apparatus addresses the need for engaging and effective educational tools in the elementary education sector. Its innovative approach fosters a love for learning, boosts mathematical proficiency, and nurtures valuable cognitive skills in young learners.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 illustrates an exemplary section of an arithmetic puzzle learning apparatus in an assembled state and using addition for a numbering system, in accordance with an embodiment of the present disclosure;

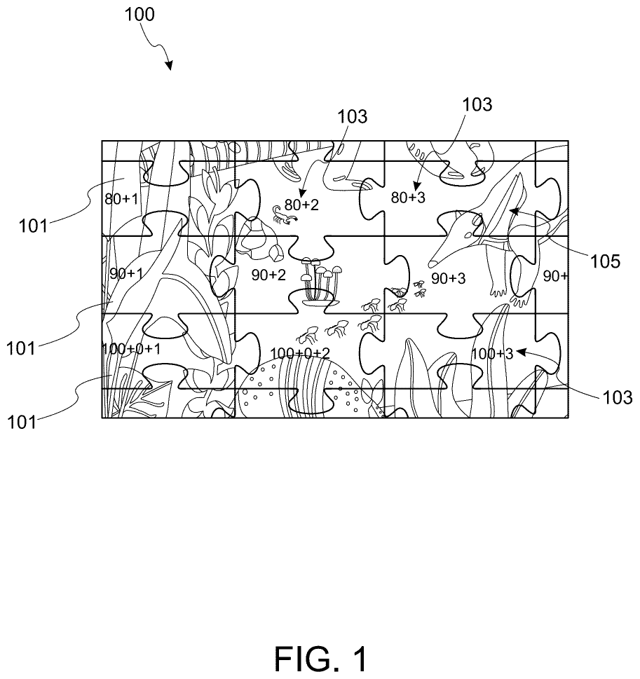

FIG. 2 illustrates an exemplary section of an arithmetic puzzle learning apparatus in an assembled state and using counting in multiples of 10 for a numbering system, in accordance with an embodiment of the present disclosure; and

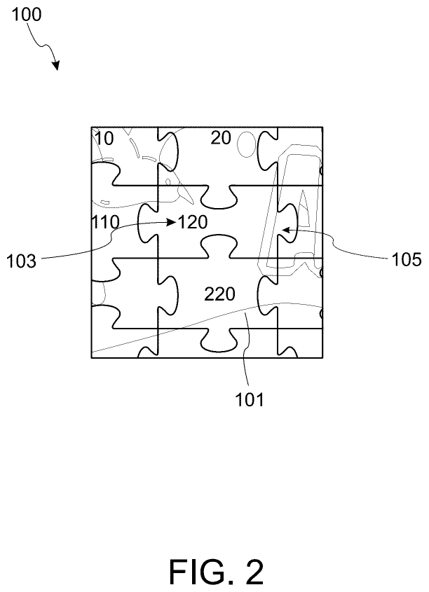

FIG. 3 illustrates an exemplary section of an arithmetic puzzle learning apparatus in a partially assembled state and using multiplication for a numbering system, in accordance with an embodiment of the present disclosure.

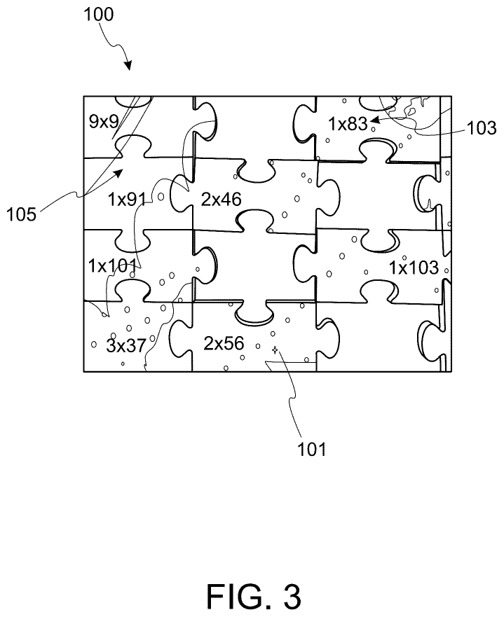

While the device of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

Illustrative embodiments of the device of the present application are provided herein. It should be appreciated that in the development of any actual embodiment, various implementation-specific decisions are required to achieve the developer's specific goals, such as compliance with system-related and business-related constraints, which vary from one implementation to another. Moreover, it should be appreciated that such a development effort might be complex and time-consuming but would nevertheless be a routine undertaking for those of ordinary skill in the art having the benefit of this disclosure.

The device should be understood, both as to its structure and operation, from the accompanying drawings, taken in conjunction with the accompanying description. Various embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility, and non-obviousness.

The arithmetic puzzle learning apparatus described herein is designed to provide an engaging and interactive learning experience for elementary age children, facilitating the comprehension and mastery of mathematical concepts. The following detailed description provides a comprehensive overview of the physical and functional aspects of the invention as well as additional features that may be incorporated into certain embodiments.

The arithmetic puzzle learning apparatus 100 of the present disclosure comprises a plurality of puzzle pieces 101 that are visually appealing, tactile, and durable to enhance user engagement and withstand repeated use. The puzzle pieces 101 can be made from various materials such as plastic, wood, foam, or any other suitable material. Each puzzle piece 101 of the plurality of puzzle pieces is uniquely designed and incorporates a numbering device 103 that may include numerical values, mathematical operators, or a combination thereof. When the number device 103 of each puzzle piece 101 is solved the pieces combine in a sequential number system to reveal an image 105.

Examples of the sequential number system that may be incorporated into some embodiments include basic counting by 1 (e.g., 1, 2, 3, 4, . . . ), more advanced counting by 10 (e.g., 10, 20, 30, . . . ), addition (e.g., 2+3=?, 6+4=?), subtraction (e.g., 10−5=?, 15−7=?), multiplication (e.g., 4×3=?, 8×2=?), division (e.g., 20÷5=?, 12÷3=?), and even more advanced math concepts such as fractions and decimals.

In an embodiment, the number device 103 of each piece 101 are grouped into sets of 10 where the number device 103 comprises multiples of 1 across the row and multiples of 10 down the columns. For example, in one embodiment, the sequential number system may include basic counting in which the number device 103 includes the whole numbers from 1 to 10 across a top row and multiples of 10 down a left-most column.

The puzzle pieces 101 can be configured as a 2-dimensional or 3-dimensional structure, depending on the specific design and educational objectives. In a 2-dimensional configuration, the puzzle pieces 101 fit together to form a flat surface and reveal an image 105, while in a 3-dimensional configuration, the puzzle pieces 101 assemble to create a three-dimensional object or sculpture and may incorporate an image 105. For example, in an embodiment, a 3-dimensional configuration may form a globe shape and feature an image of a world map on the surface.

In an embodiment, each puzzle piece 101 of the plurality of puzzle pieces is accompanied by a numbering device 103 such as an arithmetic problem to be solved by a user. These arithmetic problems create a sequential number system and can range from basic counting, addition and subtraction to more advanced counting, multiplication and division, depending on the targeted grade level and learning objectives. The arithmetic problems are carefully crafted to align with the educational curriculum to ensure a progressive learning experience.

To solve the puzzle, learners must correctly solve the arithmetic problems presented on the puzzle pieces 101. By solving these problems, the learners gradually reveal a portion of an image 105 that is concealed within the puzzle. As they progress and solve additional arithmetic problems, more of the image 105 becomes visible, encouraging learners to persist and complete the puzzle. This interactive learning environment facilitates hyperfocus, engagement and relaxation, particularly among users that struggle with ADD, ADHD, anxiety, and various other mental and behavior type challenges.

The arithmetic puzzle learning apparatus 100 may be accompanied by a set of rules and guidelines that provide instructions on how to solve the arithmetic problems and assemble the puzzle pieces 101. These guidelines ensure a structured and consistent learning experience, enabling learners to follow a logical progression and reinforce their understanding of mathematical concepts.

In an embodiment, the arithmetic puzzle learning apparatus 100 may be complemented by a physical or digital platform that displays the puzzle pieces 101 and facilitates interaction with the apparatus 100. In the case of a physical product, the platform can be a specially designed board or tray with designated spaces to place the puzzle pieces 101 as described more particularly above. In an embodiment, the board may also include additional markings or indicators to guide learners in correctly aligning the puzzle pieces 101.

In another embodiment for digital implementations, the arithmetic puzzle learning apparatus 100 may be presented as a software application, an interactive display or the like. The digital platform provides a virtual representation of the puzzle pieces 101 and allows learners to manipulate them using touch input, mouse controls or the like. The digital implementation may also incorporate interactive animations, sound effects, and visual cues to enhance the learning experience and provide immediate feedback to learners.

To facilitate the learning process, the digital implementation may incorporate various features. For example, in the digital version, learners may receive real-time feedback similar to what a live teacher could provide. The tool may evaluate the user's arithmetic problem solutions and provides immediate feedback, highlighting correct answers and offering guidance in case of errors. Learners may also have access to hints or a description and/or examples of how to solve similar math problems to further aid their understanding.

Additionally, the digital implementation may include a feature to track a learner's progress and measure it against peers or an expected standard. This feature allows for the monitoring of individual performance, identification of areas that require further attention, and the ability to set goals and benchmarks for improvement. Learners can engage in friendly competition or benchmark their progress against predetermined learning outcomes, fostering motivation and self-assessment.

In some embodiments, the arithmetic puzzle learning apparatus 100 may include additional features or components to enhance the interactive and educational nature of the invention. For example, the puzzle pieces 101 could have magnetic properties or interlocking mechanisms that ensure secure attachment when assembled. This feature adds an element of stability and allows for easy manipulation of the puzzle pieces 101.

Furthermore, the arithmetic puzzle learning apparatus 100 may include adjustable difficulty levels to accommodate learners of different skill levels. This can be achieved by providing multiple sets of puzzle pieces 101 with varying degrees of complexity or by incorporating adjustable parameters within the digital implementation.

The detailed description provided above illustrates the physical and functional aspects of the arithmetic puzzle learning apparatus 100. By combining visually appealing puzzle pieces 101, a unique number device 103 and numbering system, arithmetic problems, and a carefully designed platform, the invention offers an engaging and interactive learning experience. Whether implemented as a physical or digital product, the arithmetic puzzle learning apparatus 100 provides a versatile and effective means of teaching mathematical concepts to elementary age children, promoting active participation, pattern-seeking, and the development of critical cognitive skills.

It should be appreciated that unlike traditional puzzles where the focus is on completing an image, the arithmetic puzzle learning apparatus 100 of the present disclosure focuses the user's attention on learning and solving basic or complex mathematical problems, while learning and developing arithmetic concepts and skills, to reveal an image 105. Thus, rather than focusing on creating an image as with a traditional puzzle, the user of the arithmetic puzzle learning apparatus 100 of the present disclosure focuses on learning and the formation of an image 105 helps the user engage further in the learning process through interactive play.

It should be appreciate that the arithmetic puzzle learning apparatus 100 may be useful for various different purposes and learning environments from elementary aged children first learning basic math concepts, older students learning more advanced math concepts or refreshing already learned concepts, all the way up through adults learning or practicing the various concepts taught through the interactive play environment provided by the arithmetic puzzle learning apparatus 100.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. An arithmetic puzzle learning apparatus, comprising:
a plurality of puzzle pieces, wherein each piece of the plurality of puzzle pieces includes a numbering device corresponding to a sequential numbering system configured to assist a user with learning one or more arithmetic concepts;
wherein the user solves the numbering device that corresponds to each piece of the plurality of puzzle pieces and combines the pieces in the sequential number system to reveal an image.

2. The arithmetic puzzle learning apparatus of claim 1, further comprising a platform configured to receive and align the plurality of puzzle pieces.

3. The arithmetic puzzle learning apparatus of claim 2, wherein the platform is a physical board with designated spaces for each puzzle piece.

4. The arithmetic puzzle learning apparatus of claim 2, wherein the platform is a digital interface that allows manipulation of the puzzle pieces using controls on an input device.

5. The arithmetic puzzle learning apparatus of claim 4, wherein the platform further includes one or more interactive features to enhance the learning experience.

6. The arithmetic puzzle learning apparatus of claim 4, wherein the digital interface includes a progress tracking module to track the user's progress and provide feedback on performance.

7. The arithmetic puzzle learning apparatus of claim 1, wherein the numbering system includes at least one of basic counting, addition, subtraction, multiplication, or division.

8. The arithmetic puzzle learning apparatus of claim 1, wherein the plurality of puzzle pieces are configured to form a two-dimensional image when assembled.

9. The arithmetic puzzle learning apparatus of claim 1, wherein the plurality of puzzle pieces are configured to form a three-dimensional structure when assembled.

10. The arithmetic puzzle learning apparatus of claim 1, wherein the plurality of puzzle pieces are made from materials selected from the group consisting of plastic, wood, and foam.

11. The arithmetic puzzle learning apparatus of claim 1, further including a set of instructions on solving the numbering device and assembling the plurality of puzzle pieces.

12. The arithmetic puzzle learning apparatus of claim 1, further including a mastery completion time wherein completion of the puzzle within the mastery completion time signifies competency of the one or more arithmetic concepts.

13. The arithmetic puzzle learning apparatus of claim 1, wherein the number device corresponds to multiples of 1 across a row of 10 pieces and multiples of 10 as rows descend down a column.

14. A method of teaching one or more arithmetic concepts, the method comprising:
providing a plurality of puzzle pieces, wherein each piece of the plurality of puzzle pieces includes a numbering device corresponding to a sequential numbering system;
solving the numbering device that corresponds to each piece of the plurality of puzzle pieces;
combining the pieces of the plurality of puzzle pieces in the sequential number system to reveal an image.

15. The method of teaching one or more arithmetic concepts of claim 14, further comprising the step of presenting a platform to receive and align the plurality of puzzle pieces.

16. The method of teaching one or more arithmetic concepts of claim 14, wherein the numbering system includes at least one of basic counting, addition, subtraction, multiplication, or division.

17. The method of teaching one or more arithmetic concepts of claim 14, further comprising the step of providing a mastery completion time wherein completion of the puzzle within the mastery completion time signifies competency of the one or more arithmetic concepts.
